(19) United States
(12) Patent Application Publication
(10) Pub. No.: US 2012/0041655 A1
(43) Pub. Date: Feb. 16, 2012

(54) DEVICE FOR CONTROLLING A ROBOTISED GEARBOX OF A MOTOR VEHICLE

(75) Inventor: Arnaud Thooris, Meudon (FR)

(73) Assignee: DURA AUTOMOTIVE SYSTEMS SAS, Bievres (FR)

(21) Appl. No.: 13/255,533

(22) PCT Filed: Mar. 5, 2010
(86) PCT No.: PCT/FR10/50385

§ 371 Date: Nov. 1, 2011

(30) Foreign Application Priority Data
Mar. 12, 2009 (FR) 0951539

(51) Int. Cl. F16H 59/02

(52) U.S. Cl. 701/52

(57) ABSTRACT

A device for controlling a robotised gearbox of a motor vehicle is connected to a computer/electronic control unit to switch, at will, from a manual mode to an automatic mode. The control member is a touch screen subjected to the following steps: standby; storing of first coordinates of a digital pressure; storing of second coordinates at which the pressure is released; calculating a vector between the first and second coordinates; comparing length of the vector to a predefined length, and if the vector is shorter than the predefined length, the control member returns to standby; and if equal to or longer than the predefined length, orientation of the vector is compared to a predefined angular range; if the orientation of the vector is outside the range, the control member returns to standby; if the orientation is within the range, a desired command is validated.

The invention relates to the technical field of gearbox control means, in particular for motor vehicles.

To be more specific, the invention relates to the giving of commands to a controlled automatic box or a controlled manual box. Hereinafter, in the remainder of the description, the term robotised gearbox will be used to denote any one of this type of gearbox.

In a way perfectly well known to the man skilled in the art, a robotised gearbox may be controlled, either by a lever alone, or by combining a lever with shifts generally associated with the steering wheel.

When the control is provided solely by a lever, said lever enables a so-called sequential manual control mode and an automatic control mode.

In sequential mode, the pulses exerted on the lever make it possible, in one direction, to move up through the gears and, in the other direction, to move down through the gears. In automatic mode, the lever generally takes up the various P (Park), R (Reverse), N (Neutral), and D (Drive) positions.

When the lever is combined with the shifts, said lever generally makes it possible to switch solely from the sequential manual mode to the automatic mode. In sequential mode, the shifts are used to move up and down through the gears.

A proposal has also been made, as is clear from the teaching in patent FR 2.916.032, whereof the applicant hereto is also the proprietor, for the manual mode and the automatic mode to be selected from one and the same control member, shift or lever, and for this to happen under the effect of single pulses even in automatic mode for the engagement of the P, R, N, and D positions.

Based on this prior art, the problem the invention sets out to resolve is how no longer to use a lever and/or shifts to select and control a robotised gearbox, but to be able to use a touch screen.

A proposal has already been made regarding the use of touch screens in the motor vehicle field, for the control of an on-board navigation system for example.

However, this type of touch control cannot be used as it is in respect of safety controls, particularly in the motor vehicle field, because of the significant risk that an error can easily be made and unintentional commands generated when an object falls on the screen.

It therefore follows that if a touch screen is to be used, in the motor vehicle field, particularly for the control of a robotised gearbox, the screen needs to be made secure in order to be sure of validating the desired function so that the screen is able to be used intuitively.

To overcome these drawbacks and resolve said problem, a control device has been designed and perfected, according to the invention, for a motor vehicle robotised gearbox that is connected to an electronic computer and control unit so that it is possible to switch, at will, from a manual mode in which a control member is used to move up or down through the gears, to an automatic mode in which said member is used for the Park (P), Reverse (R), Neutral (N), Drive (D) positions.

According to the invention, the control member is a touch screen subjected to an algorithm comprising the following steps:
a standby step;
a step in which the coordinates of a digital pressure are stored;
a step in which coordinates at which the digital pressure is released are stored;
a stage in which a vector between the two points (pressure and release) is calculated;
a test step in which the length of the vector is compared to a predefined length range:
   if the vector is shorter than the predefined length, the control member returns to the standby step;
   if the vector is longer than the predefined length, a test step is validated, whereby the orientation of the vector is compared to a predefined angular range;
if the orientation of the vector is outside the predefined angular range, the control member returns to the standby step;
if the orientation of the vector is within the predefined angular range, the desired command, for example P.R.N. or D., is validated.

It follows that the touch screen is made secure for controlling and selecting the gears by analysing the coordinates of the pressure vector.

Starting from this basic design, the touch control screen may be combined with other means in order to further increase security, in order to be certain that the digital pressure and movement on said screen correspond to the function that is actually required

In a first embodiment, the touch screen is provided with an ergonomic form capable of positioning the hand, said form being provided with at least one sensor for detecting the presence of the hand on said form so that said screen which is subjected to a gear change and selection control algorithm can be activated.

The proximity sensor is of the capacitive type.

The ergonomic form is part of a stand on which the screen is mounted.

In another embodiment, at least one element is placed over the screen so as to protect the screen in its entirety with at least one cut-out to give free digital access to said screen in at least one zone capable of allowing the finger to exert pressure and/or to move corresponding to the activation of a function. The cut-out corresponds to a switch and selection grid for a robotised gearbox for a motor vehicle.

The invention is disclosed hereinafter in further detail by means of the figures in the appended drawings wherein:

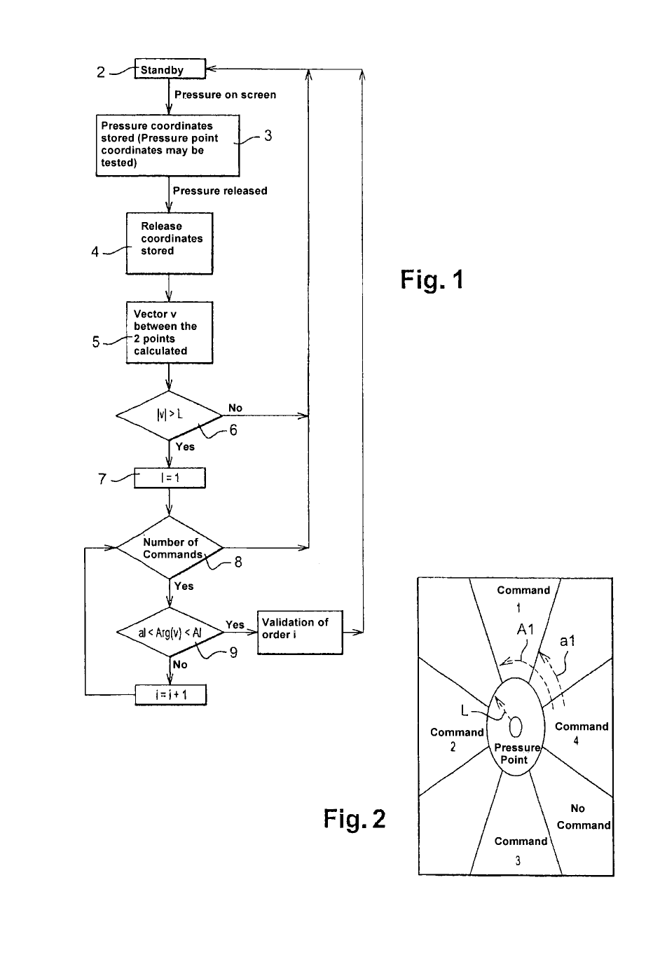

FIG. 1 is a mimic diagram of the operation to validate the touch screen controls;

FIG. 2 shows, by way of example, the description of the actions in the pressure release zone relative to the pressure point;

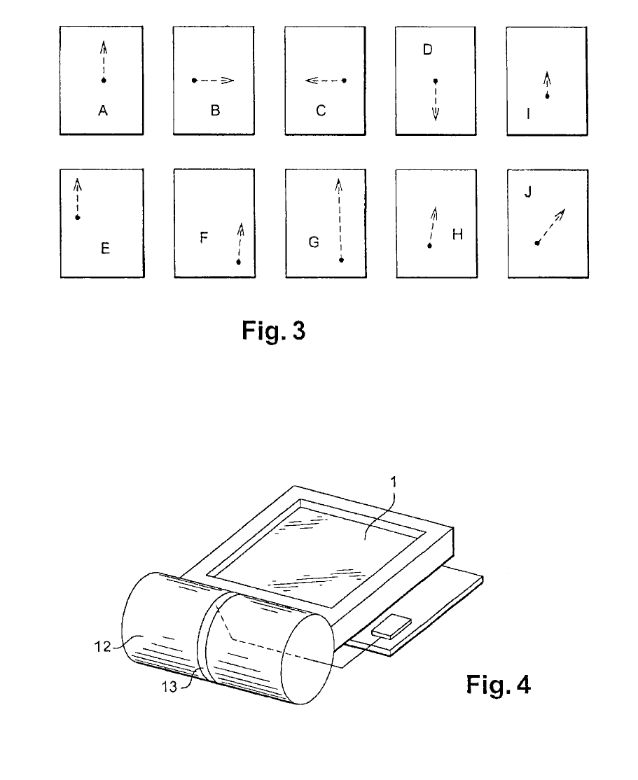

FIG. 3 shows examples of the validation or non-validation of the desired control, as a function of the length and orientation of the pressure vector;

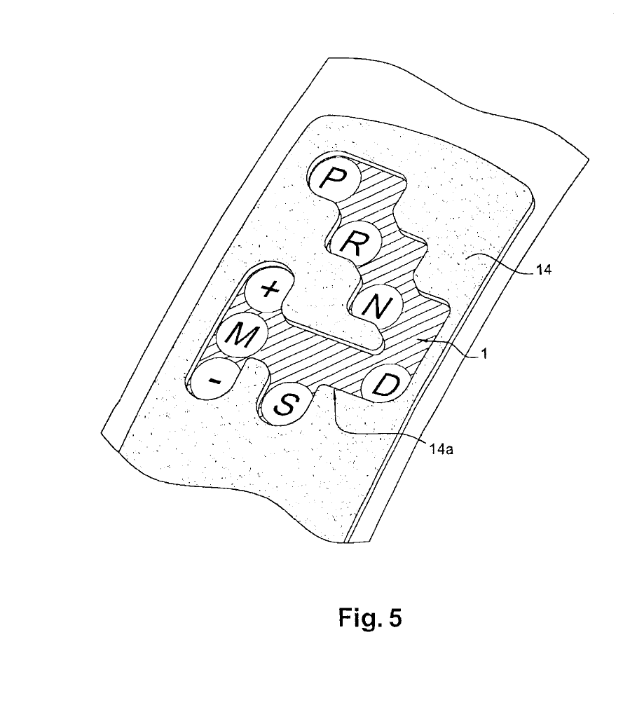

FIG. 4 is a diagrammatic perspective view, showing the touch control screen combined with an ergonomic pressure form for activating or not activating said screen;

FIG. 5 shows an embodiment in which the screen is combined with a protective element that has a cut-out corresponding to the various desired actions.

According to one underlying feature of the invention, the operating member for the control of robotised gearboxes is constituted by a touch screen (1). In other words, the touch screen (1), in the same way as a lever or shifts, is connected, in a way perfectly known to the man skilled in the art, to a computer and an electronic control unit so that it is possible to switch, at will, from a sequential manual mode, in which a control member is used to move up and down through the gears, to an automatic mode in which said member is used to for the P, R, N, or D positions.

The invention relates more specifically to making the touch screen (1) secure so as to avoid any unintentional validation of an action to switch and/or select a gear. In other words, according to the invention, a command or action will only be confirmed after a movement on the screen in predefined conditions, in order to avoid any operator error and allowing it to be used with no requirement to look at the screen.

Generally speaking, according to the prior art, a command is validated by pressure exerted upon an area of the touch screen. It is therefore the pressure point coordinates which will be able to define the command to be executed.

According to the underlying characteristics of the inventive device, the command is validated after a movement of the pressure point. In other words, the length and direction of a vector between the pressure start and end points need to be defined and calculated. If the vector norm is too low, in the sense that it is outside the field of the predefined characteristics of the vector, the command will not be executed.

To advantage, the pressure start zone may be either defined, or totally free. In the latter case, the command may be executed but with no requirement for the user to look at the touch screen.

Reference may be made to FIG. 3, which shows four characteristics of the vector each corresponding to the execution of a command, namely command 1, command 4, command 2, command 3. For example, these commands 1, 2, 3, 4 correspond to the P, R, N, and D positions of the gearbox. The diagrams A, B, C, D, correspond to the “ideal” circumstance for executing the desired command from a pressure point to the release point generating a vector, for example, bottom-up for command 1, left-to-right for command 4, right-to-left for command 2, and top-down for command 3.

Of course, for each of these commands, between the pressure point (P1) and release point (P2), a zone Z1, Z2, Z3, Z4, for each of the commands 1, 2, 3 and 4, is allowed in order to validate said command (FIG. 2). In FIG. 3, for example, the validation of the command (1) can be seen with different start points of the pressure point and length vectors of different direction (diagrams E, F, G, H). Conversely, the diagram (I) shows a vector of insufficient length and the diagram (J) a vector whereof the orientation goes beyond the permissible zone. In diagrams (I) and (J), the command is not validated.

The mimic diagram of the operation to validate the commands is shown in FIG. 1. The touch screen (1) is subjected to an algorithm which includes the following steps:
a standby step (2);
after pressure on the screen (1), the pressure coordinates are stored (step (3));
the pressure is released and release coordinates are stored (step (4)).

From these two pieces of stored data (pressure and release), it is possible to calculate, using appropriate software, the vector between these two points (step (5)).

This calculation step (5) is followed by a test step (6) in which the length of the vector is compared to a predefined length (L). If the vector is shorter than the length (L), the control member returns to the standby step (2). If the vector is equal to or longer than the length (L), a test step (9) is validated, for each of the commands 1, 2, 3, 4, for example steps (7) and (8), in which the direction and orientation of the vector are compared relative to the predefined range.

If the orientation and direction of the vector are outside the predefined range, the control member returns to the standby step (2), if the orientation and direction of this vector are within the predefined range, the desired command, command 1, command 2, command 3, command 4, corresponding, for example, to the P, R, N, and D positions, as shown, is validated.

These technical provisions therefore enable a command to be validated only if the pre-set conditions and characteristics of the vector between a pressure point and a release point on the touch screen are respected. All unintentional and inadvertent commands are consequently avoided.

Starting with this basic concept of calculating the vector coordinates in order to validate or not validate a command, it is therefore possible to increase the security of operation by combining the touch screen (1) with specific means.

In FIG. 4, the touch screen (1) is provided with an ergonomic form (12) capable of positioning the hand. This form (12) is provided with at least one sensor (13) for detecting the presence of the hand on said form in order to activate the screen (1). In the absence of detection, no touch screen command is possible. The proximity sensor (13) may be of any known and appropriate type, such as a mechanical contact switch, optical sensor, capacitive sensor, inductive sensor. To advantage, the sensor is of the capacitive type in order to detect the proximity of the hand on the ergonomic form (12). The presence of the hand detected by the sensor (13) is processed by software in order to activate the screen.

Dual security is consequently obtained, on the one hand, by detecting the presence of the hand at a determined place of the screen and, on the other hand, by calculating the vector resulting from the pressure point and release point of the command under consideration.

In FIG. 5, the screen (1) includes at least one protective element (14) having at least one cut-out (14a) to give a free digital access to said screen, in at least one zone capable of allowing the finger to exert pressure and/or to move corresponding to the activation of the desired command. For example, in the example shown, the cut-out (14a) corresponds to a switch and selection grid for a robotised gearbox with the positions P, R, N, D and M+ and M−. This protective element (14) is not in contact with the touch screen and may be made out of any material.

These arrangements make it possible to advantage to be able to use the screen for the control of the gearbox, with no requirement to look at the screen as such. It should also be noted that these arrangements make it possible to determine, in a precise manner, the positioning of the pressure point of the vector under consideration.

The advantages are quite clear from the description.

1. Device for controlling a robotised gearbox of a motor vehicle connected to an electronic computer and a control unit so that it is possible to switch, at will, from a manual mode, in which a control member is used to move up or down through the gears, to an automatic mode, in which the control member is used for Park (P), Reverse (R), Neutral (N), and Drive (D) commands, wherein the control member is a touch screen subjected to a control process comprising the following steps:
a standby step;
a step in which first coordinates of a digital pressure are stored;
a step in which second coordinates at which the digital pressure is released, are stored;
a step in which a vector between the first coordinates and the second coordinates is calculated;
a test step in which length of the vector is compared to a predefined length, and:
if the vector is shorter than the predefined length, the control member returns to the standby step; and
if the vector is equal to or longer than the predefined length, a test step is validated, whereby orientation of the vector is compared to a predefined angular range; and
if the orientation of the vector is outside the predefined angular range, the control member returns to the standby step; and
if the orientation of the vector is within the predefined angular range, a desired command is validated.

2. Device as claimed in claim 1, wherein the touch screen has an ergonomic form positioning a hand, said form including at least one proximity sensor detecting presence of the hand on said form so that said screen is activated.

3. Device as claimed in claim 2, wherein the proximity sensor comprises a capacitive sensor.

4. Device as claimed in claim 2, wherein the ergonomic form is part of a stand upon which the screen is mounted.

5. Device as claimed in claim 1, wherein at least one element for protecting the screen is placed over the screen and has at least one cut-out to give free digital access to said screen in at least one zone allowing a finger to exert pressure and/or move corresponding to activating a function.

6. Device as claimed in claim 5, wherein the cut-out corresponds to a robotised gearbox switch and selection grid for a motor vehicle.
